(19) United States
(12) Patent Application Publication
(10) Pub. No.: US 2026/0079426 A1
(43) Pub. Date: Mar. 19, 2026

(54) IMAGE FORMING APPARATUS AND DEVELOPER FILLING METHOD

(71) Applicant: CANON KABUSHIKI KAISHA, Tokyo (JP)

(72) Inventors: Kazuki Matsumoto, Shizuoka (JP); Hiroomi Matsuzaki, Shizuoka (JP); Tatsuro Harada, Shizuoka (JP)

(21) Appl. No.: 19/322,926

(22) Filed: Sep. 9, 2025

(30) Foreign Application Priority Data
Sep. 13, 2024 (JP) 2024-159527

(51) Int. Cl. G03G 15/08

(52) U.S. Cl. CPC G03G 15/0891; G03G 15/0808; G03G 15/0875; G03G 15/0886

(57) ABSTRACT

An image forming apparatus including: an apparatus main body including a developing unit having a developing roller for supplying, to a photosensitive drum, developer from a receiving port; a developer container that contains the developer, is provided with a discharge port; and a developer conveyance passage that connects the discharge port and the receiving port, wherein the apparatus main body includes an intake and exhaust portion that is capable of performing an exhaust operation to the developer container and an intake operation from the developer container, and the intake and exhaust portion forms a first flow of air flowing from the developer container to the developing unit through the developer conveyance passage by the exhaust operation to supply the developer to the developing unit, and forms a second flow of air flowing from the developing unit to the developer container through the developer conveyance passage by the intake operation.

### BACKGROUND

### Field of the Technology

The present disclosure relates to an image forming apparatus.

### Description of the Related Art

In an image forming apparatus of an electrophotographic system, a configuration is known in which a toner storage unit (developer container) containing a toner (developer) to be used for image formation is attachable to and detachable from the apparatus main body separately from a developing unit for performing an electrophotographic process. For conveying toner from a toner storage unit to a developing unit, a configuration in which the toner is conveyed by two types pumps: an exhaust pump for exhausting air and a suction pump for sucking the toner and air is available as disclosed in, for example, Japanese Patent Application Publication No. 2007-249151. The toner storage unit according to Japanese Patent Application Publication No. 2007-249151 is configured such that the toner fluidized by air flowing into a toner storage portion of the toner storage unit from the exhaust pump is collected to the lower part of the toner storage portion and is conveyed by using an inclined surface provided at the bottom of the toner storage portion. Then, the toner collected in the lower part of the toner storage portion while being fluidized by mixed air is sucked by the suction pump to be conveyed to the developing unit of the image forming apparatus.

In this configuration, since the developing unit has a rotating member such as a developer supply roller, if the toner continues to stay in the developing unit, the toner may be degraded by rubbing. The degraded toner adversely affects image formation. In order to avoid this problem, it is effective to keep the amount of toner constant in the developing unit. For this reason, it is desirable to convey a stable amount of toner to the developing unit. However, when toner is conveyed with an air flow as described above, the toner that has not reached the developing unit may accumulate in a toner conveyance passage. The amount of accumulating toner may vary with various factors. If subsequent toner is conveyed in this state, variations in the amount of accumulated toner are added, resulting in an unstable amount of conveyed toner.

### SUMMARY

The present disclosure is directed to provide a technique for stabilizing the amount of a developer conveyed from a developer container to a developing unit.

In order to solve the above problem, an image forming apparatus that forms an image on a recording material according to the present disclosure includes:
an apparatus main body having a photosensitive drum and a developing unit provided with a receiving port for receiving developer, the developing unit having a developing roller for supplying, to the photosensitive drum, the developer received from the receiving port;
a developer container that contains the developer, is provided with a discharge port, and is attachable to and detachable from the apparatus main body; and
a developer conveyance passage that connects the discharge port and the receiving port,
wherein the apparatus main body includes an intake and exhaust portion that is capable of performing an exhaust operation and an intake operation, the exhaust operation is to supply air to the developer container to form a flow of air flowing from the developer container to the developing unit through the developer conveyance passage and supply the developer from the developer container to the developing unit, and the intake operation is to suck air from the developer container to form a flow of air flowing from the developing unit to the developer container through the developer conveyance passage.

In order to solve the problem, a method for filling a developer container with a developer, the developer container being attachable to and detachable from the apparatus main body of an image forming apparatus of the present invention,
wherein the developer container includes:
   a developer storage chamber that stores the developer and is provided with a discharge port for the developer;
   a filter that allows passage of air and prevents passage of the developer; and
   an air chamber that is separated from the developer storage chamber by the filter and is provided with an air receiving port for receiving air supplied from an intake and exhaust portion of the apparatus main body,
wherein the air chamber is configured to be mounted, in the apparatus main body, in a position located under the developer storage chamber, and
wherein in a case where the developer storage chamber is to be filled with the developer, the air chamber is positioned on the developer storage chamber, and the developer is supplied into the developer storage chamber from the discharge port while air is sucked from the air receiving port, the discharge port serving as a developer filling port.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view showing an image forming apparatus according to a first embodiment.

FIG. 2 is a cross-sectional view showing a developing unit according to the first embodiment.

FIG. 3 is a cross-sectional view showing a toner storage unit according to the first embodiment.

FIG. 4 is a cross-sectional view showing the toner storage unit and the developing unit according to the first embodiment.

FIG. 5A is a cross-sectional view in which the volume of air intake and exhaust unit changes in the direction of an arrow D1, a direction in which the pump volume decreases, in the toner storage unit and the developing unit according to the first embodiment.

FIG. 5B is a cross-sectional view in which the volume of the air intake and exhaust unit changes in the direction of an arrow D2, a direction in which the pump volume increases, in the toner storage unit and the developing unit according to the first embodiment.

FIG. 6A is a cross-sectional view showing a state in which a flow passage is formed for air intake and exhaust unit drawing, from the outside, air for forming an exhaust flow in an exhaust operation for supplying toner from a toner storage unit to a developing unit, in the toner storage unit and the developing unit according to a second embodiment.

FIG. 6B is a cross-sectional view showing a state in which a flow passage is formed for the air intake and exhaust unit discharging air, which is drawn from the outside, to the toner storage unit through a first conveyance passage and a second conveyance passage in the exhaust operation in the toner storage unit and the developing unit according to the second embodiment.

FIG. 7A is a cross-sectional view showing a state in which a flow passage is formed for sucking air from the toner storage unit to the air intake and exhaust unit in an intake operation for sucking air from the toner storage unit and the developing unit, in the toner storage unit and the developing unit according to the second embodiment.

FIG. 7B is a cross-sectional view showing a state in which a flow passage is formed for the air intake and exhaust unit discharging air, which is sucked from the toner storage unit, by the intake operation in the toner storage unit and the developing unit according to the second embodiment.

FIG. 8 is a cross-sectional view of the toner storage unit according to a modification example of the second embodiment.

### DESCRIPTION OF THE EMBODIMENTS

Modes for carrying out the present disclosure will now be described in detail by way of illustration on the basis of embodiments in conjunction with the accompanying drawings. However, it should be understood that the dimensions, materials, shapes, and relative arrangement of the components described in the embodiments should be modified as appropriate depending on the configuration of the apparatus to which the disclosure is applied and on various other conditions. In other words, the scope of the present disclosure is not intended to be limited to the embodiments described below. In addition, although a plurality of features are described in the embodiments, all of the plurality of features are not necessarily essential to the disclosure, and the plurality of features may be combined in any way. Moreover, in the accompanying drawings, the same reference numerals are assigned to the same or similar components, and redundant descriptions thereof are omitted.

Examples of the image forming apparatus in the following description include a copying machine, a printer, a composite machine, and a commercial printing machine. An image is formed on a recording medium (recording material) on the basis of image information input from an external computer and image information read from an original. Used as the recording medium are paper such as plain paper and thick paper, a plastic film, coated paper, a sheet in a special form, e.g., an envelope or index paper, and sheet materials of various materials and shapes, e.g., fabrics.

### First Embodiment

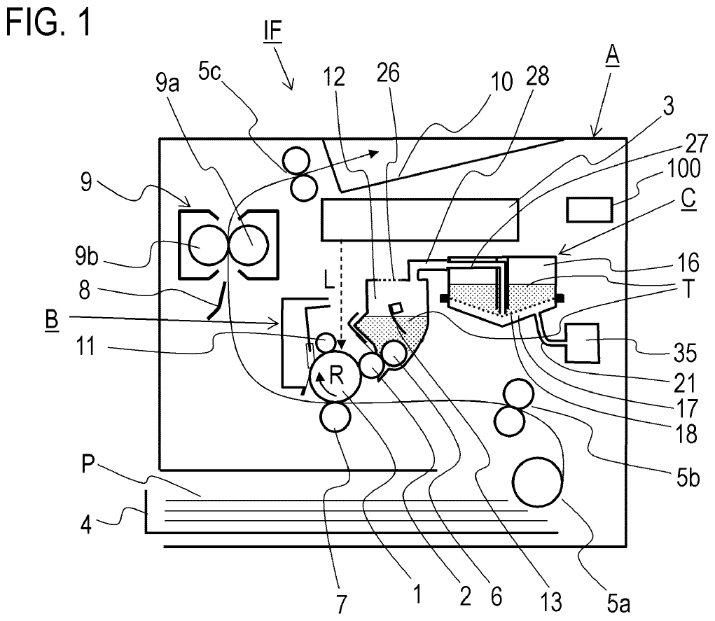

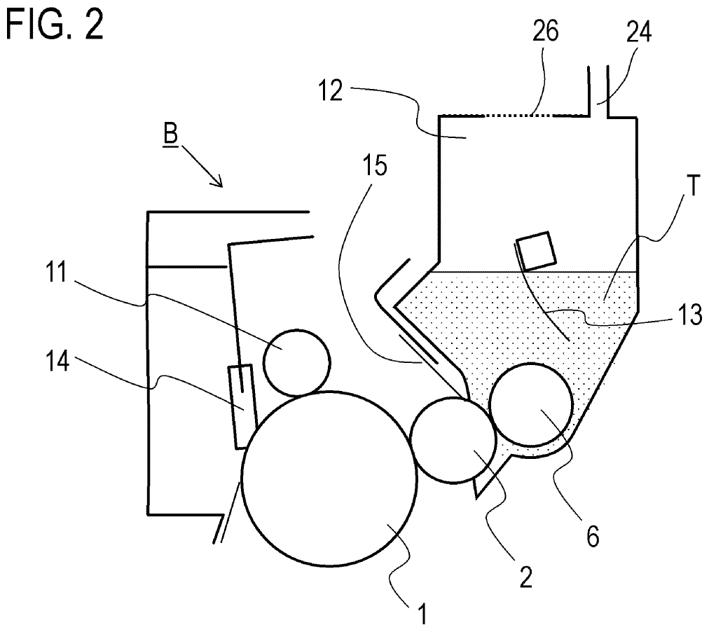

FIG. 1 is a schematic diagram showing a cross-sectional configuration of an image forming apparatus IF according to a first embodiment of the present disclosure. FIG. 2 shows a developing unit B. As shown in FIG. 1, the developing unit B and a toner storage unit C are installed in an apparatus main body A of the image forming apparatus IF and form an image on a sheet P, which is a recording medium. The apparatus main body A is a part in which the developing unit B and the toner storage unit C are removed from the image forming apparatus IF.

### Configuration of Overall Image Forming Apparatus

As shown in FIG. 1, the image forming apparatus IF according to the present embodiment is an electrophotographic laser beam printer. The apparatus main body A includes, in addition to the installation portions of the developing unit B and the toner storage unit C, a pickup roller 5a, a conveyance roller pair 5b, a transfer roller 7, a fixing apparatus 9, a discharge roller pair 5c, and a discharge tray 10 along a direction that conveys the sheet P from a sheet tray 4. The apparatus main body A includes a control portion 100 that controls the operations or the like of the configurations of the image forming apparatus IF. The control portion 100 controls the operations of parts constituting air intake and exhaust unit 135 in the exhaust and intake operations of the air intake and exhaust unit 135, which will be described later.

The developing unit B includes a photosensitive drum 1 as a photosensitive member, a developing roller 2 as a developer bearing member, a charging roller 11 as charging member, and a toner chamber 12 as a developer storage part that stores a toner T to be supplied to the developing roller 2. The toner storage unit C as a developer container stores the toner T to be supplied to the toner chamber 12 of the developing unit B.

### Image Forming Process

When the image forming apparatus IF receives a signal to start image formation on the sheet P, the photosensitive drum 1 is driven to rotate in the direction of an arrow R in FIG. 1. The charging roller 11 is in contact with the outer peripheral surface of the photosensitive drum 1 to uniformly and evenly charge the surface of the photosensitive drum 1. A laser scanner 3 irradiates the photosensitive drum 1 with a laser beam L based on image information, and performs an exposure operation to write an electrostatic latent image on the surface of the photosensitive drum 1.

The toner T stored in the toner chamber 12 is delivered to a sponge-like developer supply roller 6 by the stirring member 13. The toner T is then supplied to the developing roller 2 by the developer supply roller 6 and is supported as a thin layer on the surface of the developing roller 2 by a developing blade 15 (see FIG. 2). The toner T that has reached a developing zone where the developing roller 2 and the photosensitive drum 1 face each other is transferred from the developing roller 2 to the surface of the photosensitive drum 1 according to the potential distribution on the surface of the photosensitive drum 1. Thus, the electrostatic latent image on the surface of the photosensitive drum 1 is visualized as a toner image.

In parallel with such a process, the sheet P is fed at the timing synchronized with an exposure operation by the laser scanner 3. The pickup roller 5a shown in FIG. 1 delivers the sheet P placed on the sheet tray 4 from the sheet tray 4. The conveyance roller pair 5b receives the sheet P from the pickup roller 5a and conveys the sheet P to a transfer portion between the photosensitive drum 1 and the transfer roller 7. Thereafter, a bias voltage is applied to the transfer roller 7, so that the toner image borne on the photosensitive drum 1 is transferred to the sheet P.

The sheet P with the toner image transferred thereon is conveyed to the fixing apparatus 9 along a conveyance guide 8. The fixing apparatus 9 applies heat and pressure to the toner image on the sheet P by a heat roller 9a and a pressure roller 9b to fix the image on the sheet P. The sheet P on which the image has been fixed is discharged to the discharge tray 10, which is provided in the upper part of the apparatus main body A, by the discharge roller pair 5c.

### Developing Unit

Referring to FIG. 2, an overview of the configuration of the developing unit B will be described below. The developing unit B of the present embodiment includes a receiving port 24 that receives the toner T supplied from the toner storage unit C, in addition to the photosensitive drum 1, the charging roller 11, the developing roller 2, the developing blade 15, the developer supply roller 6, and the toner chamber 12.

### Description of Parts of Toner Storage Unit

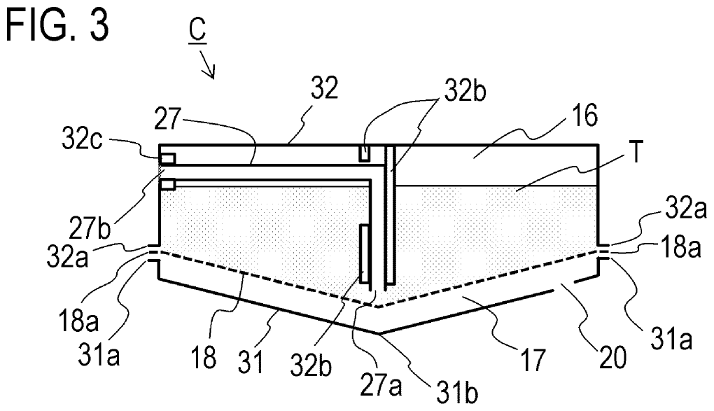

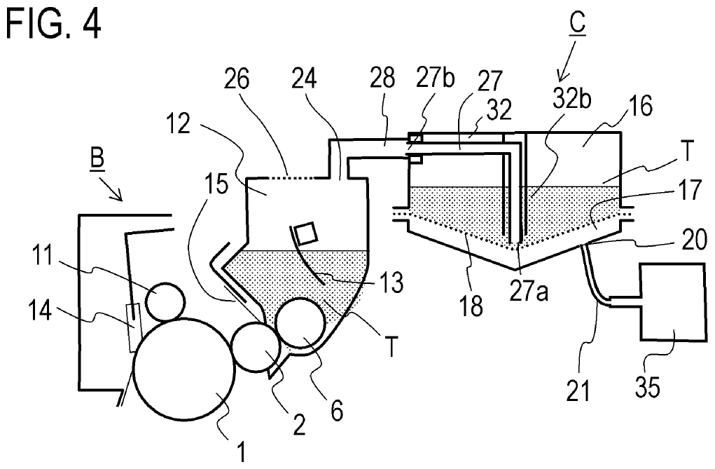

After a description of the overall configuration overview of the toner storage unit, each part will be described. FIG. 3 is a cross-sectional view of the toner storage unit. FIG. 4 is a cross-sectional view of the toner storage unit and the developing unit.

First, the overall configuration overview of the toner storage unit C will be described below. As shown in FIG. 3, the toner storage unit C includes a first frame 31 and a second frame 32. A first filter 18 as a first ventilation member is disposed between the first frame 31 and the second frame 32, and a first frame flange 31a, a second frame flange 32a, and a filter flange 18a are joined.

With this configuration, the first filter 18 divides (partitions) the toner storage unit C into a toner storage portion 16 (developer storage chamber) and an air chamber 17. The toner storage portion 16 is provided with a first conveyance passage 27, and the air chamber 17 is provided with an air port 20 (air receiving port). The air chamber 17 is located under the toner storage portion 16.

The toner storage portion 16 will be described below. As shown in FIG. 3, the toner storage portion 16 is a space that is surrounded by the second frame 32 and the first filter 18 at the bottom and stores the toner T. The second frame 32 has a first inflow/outflow port support portion 32b and supports the vicinity of a first inflow/outflow port 27a of the first conveyance passage 27. The second frame 32 has a second inflow/outflow port support portion 32c and supports a second inflow/outflow port 27b (discharge port) of the first conveyance passage 27. The first inflow/outflow port support portion 32b may be integrated with the second frame 32 constituting the toner storage portion 16, or the first inflow/outflow port support portion 32b, which is a member separate from the second frame 32, may be fixed to the second frame 32.

The air chamber 17 will be described below. As shown in FIG. 3, the air chamber 17 is a space that is enclosed by the first frame 31 and the first filter 18 with the first filter 18 serving as the ceiling surface and is a continuous space. As shown in FIG. 1, in a state in which the toner storage unit C is installed in the apparatus main body A, the air port 20 is connected to air intake and exhaust unit 35, allowing air to flow in and out of the air port 20.

The first filter 18 will be described below. The first filter 18 is, for example, a porous member composed of resin fibers and has a pore size and density that allow the passage of air but prevents the passage of the toner T. Furthermore, the first filter 18 may be made of, for example, a filter material to be molded by hot press or the like.

The first conveyance passage 27 will be described below. As shown in FIG. 4, the first conveyance passage 27 is a passage formed by a cylindrical communicating tube (first tube). One end of the first conveyance passage 27 is the first inflow/outflow port 27a provided in the toner storage portion 16, and the other end of the first conveyance passage 27 is the second inflow/outflow port 27b communicating with the outside of the toner storage unit C. The first conveyance passage 27 may be selected as appropriate from a flexible tube made of rubber or silicon and a hollow member such as a resin or metal pipe. The first inflow/outflow port 27a, which is opened to the inside of the toner storage portion 16 in the first conveyance passage 27, opens so as to face the first filter 18, and the first filter 18 has a concave shape in which an area facing the first inflow/outflow port 27a is most recessed downward.

A second conveyance passage 28 will be described below. As shown in FIG. 4, the second conveyance passage 28 is a passage formed by a cylindrical communicating tube (second tube) that connects the toner storage unit C and the developing unit B in a state in which the toner storage unit C and the developing unit B are mounted in the apparatus main body A. One end of the second conveyance passage 28 is connected to the second inflow/outflow port 27b (discharge port) of the toner storage unit C, and the other end of the second conveyance passage 28 is connected to the receiving port 24 of the developing unit B. Like the first conveyance passage 27, the second conveyance passage 28 may be selected from a flexible tube made of rubber or silicon and a hollow member such as a resin or metal pipe as appropriate.

A second filter 26 (second filter) will be described below. As shown in FIG. 4, the second filter 26 as a second ventilation member is a ventilation member disposed on the top of the toner chamber 12 of the developing unit B. Like the first filter 18, the second filter 26 is, for example, a porous member composed of resin fibers and has a pore size and density that allow the passage of air but prevents the passage of the toner T. Although the second filter 26 is installed in the developing unit B in the present embodiment, the second filter 26 may be installed in the vicinity of the developing unit B in the second conveyance passage 28.

As described above, air exhausted by the air intake and exhaust unit 35 shown in FIG. 4 is allowed to pass through only a single passage such that air passes through the first conveyance passage 27 and the second conveyance passage 28 from the air port 20 through the first filter 18 and is discharged out of the developing unit B from the second filter 26. This configuration allows toner replenishment and collection of accumulated toner as will be described later.

Furthermore, the toner storage unit C and the developing unit B of the present embodiment may be attachable to and detachable from the apparatus main body A.

### Mechanism for Toner Replenishment

Referring to FIG. 4, a mechanism for discharging the toner T from the toner storage unit C and replenishing the developing unit B with the toner will be described below. In the present embodiment, the apparatus main body A includes the air intake and exhaust unit 35 as an intake and exhaust portion. The air intake and exhaust unit 35 can perform an exhaust operation of supplying air to the toner storage unit C to form an air flow for supplying the toner from the toner storage unit C to the developing unit B through the first conveyance passage 27 and the second conveyance passage 28 that serve as developer conveyance passages.

In the present embodiment, air exhausted by the air intake and exhaust unit 35 provided in the apparatus main body A forms an airflow (first flow) from the air port 20 to the outside of the second filter 26. The airflow conveys the toner T from the toner storage portion 16 to the outside of the toner storage unit C and replenishes the developing unit B with the toner.

The details will be described below. As shown in FIG. 4, the air intake and exhaust unit 35 of the apparatus main body A according to the present embodiment is connected to the air port 20 of the air chamber 17 via an air pipe 21. As described above, air exhausted by the air intake and exhaust unit 35 is delivered to the air chamber 17 through the air port 20 of the toner storage unit C. The air flowing fully into the air chamber 17 passes through the first filter 18 forming a ceiling surface. The air then passes through the first filter 18 and flows into the toner storage portion 16. The air flowing into the toner storage portion 16 fluidizes the toner T in the toner storage portion 16. The air mixed with the toner T sequentially passes through the first conveyance passage 27, the second inflow/outflow port 27b, and the second conveyance passage 28 from the first inflow/outflow port 27a and flows out of the second filter 26. The toner T that cannot pass through the second filter 26 remains in the toner chamber 12 of the developing unit B. That is, the developing unit B can be replenished with the toner T of the toner storage unit C by the flow of air exhausted from the air intake and exhaust unit 35. At this time, the toner that has flowed out of the toner storage portion 16 but has not reached the toner chamber 12 is accumulated in the first conveyance passage 27 and the second conveyance passage 28 (hereinafter referred to as “accumulated toner”).

### Mechanism for Collecting Accumulated Toner

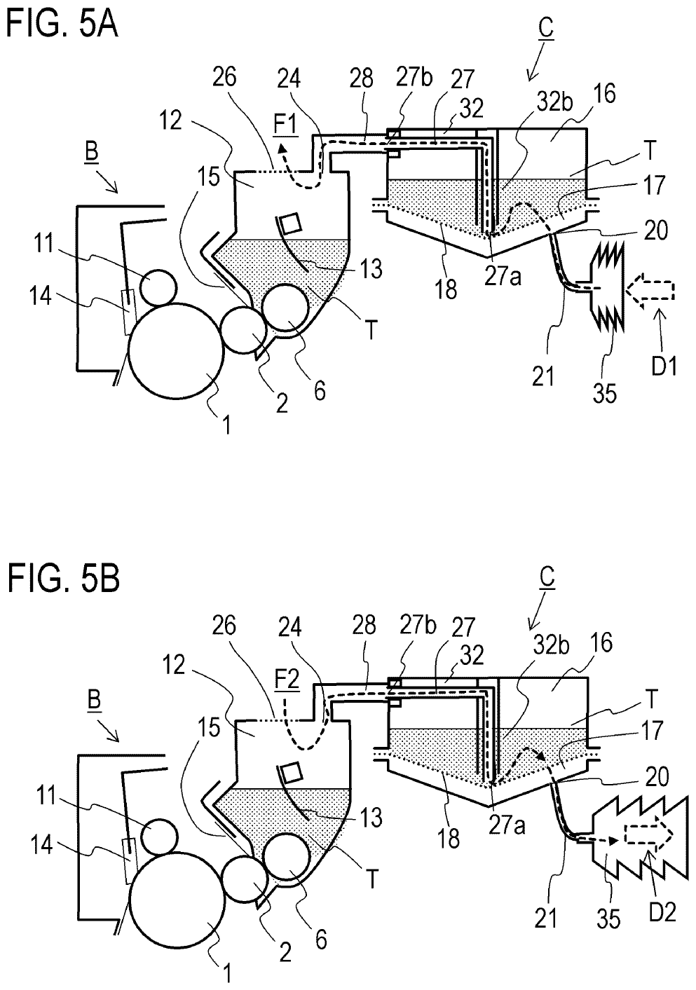

Referring to FIGS. 5A and 5B, a mechanism for collecting the accumulated toner in the first conveyance passage 27 and the second conveyance passage 28 into the toner storage portion 16 after the replenishment will be described below. The air intake and exhaust unit 35 can perform an air intake operation of sucking air from the toner storage unit C to form an airflow from the developing unit B to the toner storage unit C through the first conveyance passage 27 and the second conveyance passage 28.

The air intake and exhaust unit 35 of the present embodiment is composed of a flexible container portion having a variable volume and an air-port connection portion (intake and exhaust port) that communicates the inner space (interior) and the outside. That is, the air intake and exhaust unit 35 exhausts air from the air-port connection portion by reducing the volume of the flexible container portion with a pressing force or the like, and sucks air from the air-port connection portion by increasing the volume of the flexible container portion with a tensile stress or the like. For example, a bellows pump is shown in FIGS. 5A and 5B. In the present embodiment, Vp>V1+V2 is set where Vp is the variable volume of the air intake and exhaust unit 35, V1 is the volume of the first conveyance passage 27, and V2 is the volume of the second conveyance passage 28.

As shown in FIG. 5A, when the volume of the air intake and exhaust unit 35 changes by Vp in the direction of an arrow D1, a direction in which the pump volume decreases, the exhausted air produces an airflow F1 (first flow) at the time of toner replenishment, so that the toner chamber 12 can be replenished with the toner T as described above.

Thereafter, as shown in FIG. 5B, when the volume of the air intake and exhaust unit 35 changes by Vp in the direction of an arrow D2, a direction in which the pump volume increases, outside air is sucked from the second filter 26. Since the amount of air to be sucked corresponds to Vp, an airflow F2 (second flow) at the time of collection of accumulated toner is produced, in which the air is mixed with toner accumulated in the second conveyance passage 28 and the first conveyance passage 27 and reaches the toner storage portion 16 through the first inflow/outflow port 27a. Thus, at least part of the toner accumulated in the first conveyance passage 27 and the second conveyance passage 28 in the present configuration can be collected in the toner storage portion 16. The air further passes through the first filter 18 and reaches the air intake and exhaust unit 35.

As described above, air is allowed to flow in the direction opposite to the airflow during the conveyance of the toner to disentangle the toner accumulated in the conveyance passages, and at least part of the accumulated toner can be collected into the toner storage portion 16. This can reduce the amount of accumulated toner. If subsequent toner replenishment is performed in this state, only toner conveyed from the toner storage portion 16 is mainly conveyed to the toner chamber 12, so that variations in the amount of replenishment can be reduced and the amount of conveyed toner can be stabilized.

### Second Embodiment

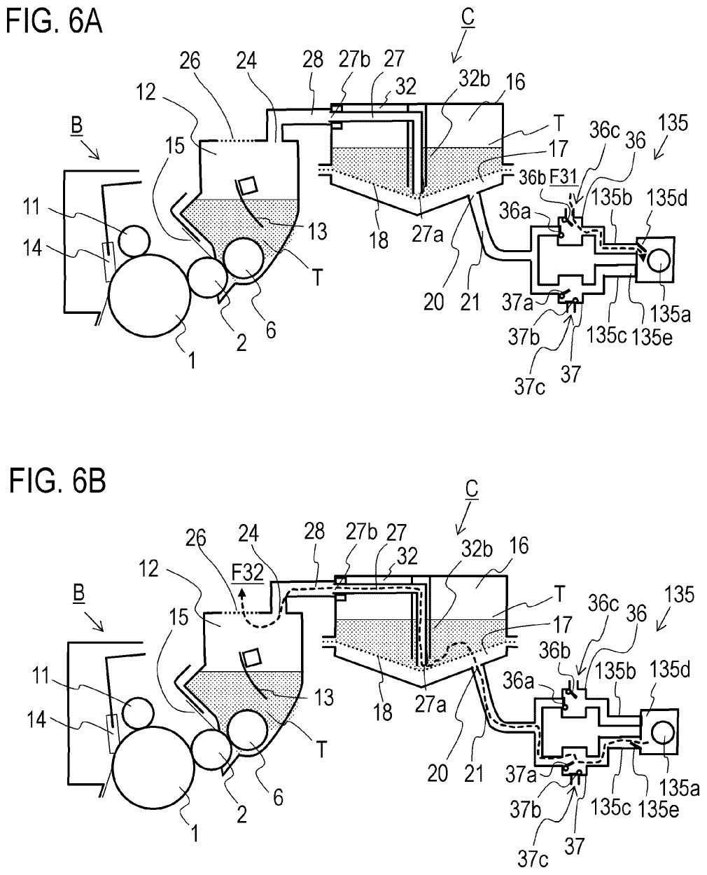

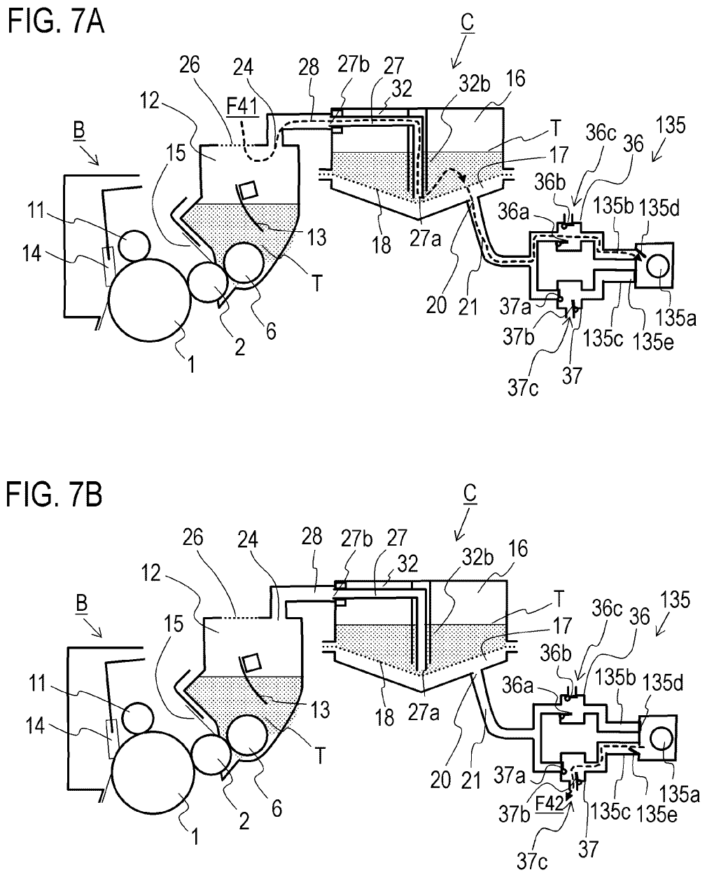

Referring to FIGS. 6A to 7B, a second embodiment of the present disclosure will be described below. In the second embodiment, differences from the first embodiment will be mainly described. The same components as those described in the first embodiment are denoted by the same reference numerals, and a repeated description thereof is omitted. In the second embodiment, matters not specifically described are similar to those of the first embodiment.

The configuration of the present embodiment is different from the first embodiment in that Vp<V1+V2 is set where Vp is the variable volume of air intake and exhaust unit 135, V1 is the volume of a first conveyance passage 27, and V2 is the volume of a second conveyance passage 28. Also in this configuration, toner replenishment and collection of accumulated toner can be performed.

### Configuration of Air Intake and Exhaust Means

As shown in FIG. 6A, the air intake and exhaust unit 135 of the present embodiment includes a volume changing portion (volume varying portion) 135a, and an intake passage 135b and an exhaust passage 135c that are connected to the volume changing portion 135a. Furthermore, the intake passage 135b has an intake passage valve 135d that is opened when the volume of the volume changing portion 135a increases, and the exhaust passage 135c has an exhaust passage valve 135e that is opened when the volume of the volume changing portion 135a decreases. The volume changing portion 135a can slightly increase and reduce the volume in a continuous manner, thereby repeating air intake and exhaust. The volume changing portion 135a is, for example, a diaphragm pump.

An intake air switching portion 36 is provided between the intake passage 135b and an air port 20. The intake air switching portion 36 has a connection port to the intake passage 135b, a connection port to an air pipe 21 connected to the air port 20, and a communication port with outside air. The connection port to the air pipe 21 has an air-port-side intake valve 36a that can be opened and closed as needed, and the connection port to outside air has an outside-air-side intake valve 36b that can be opened and closed as needed.

An exhaust air switching portion 37 is provided between the exhaust passage 135c and the air port 20. The exhaust air switching portion 37 has a connection port to the exhaust passage 135c, a connection port to the air pipe 21 connected to the air port 20, and a communication port with outside air. The connection port to the air pipe 21 has an air-port-side exhaust valve 37a that can be opened and closed as needed, and the connection port to outside air has an outside-air-side exhaust valve 37b that can be opened and closed as needed.

### Airflow at Time of Toner Replenishment

Referring to FIGS. 6A and 6B, an airflow at the time of toner replenishment will be described below. FIG. 6A shows a state in which a flow passage (first intake passage) is formed for the air intake and exhaust unit 135 drawing, from the outside, air for forming an exhaust flow in an exhaust operation for supplying toner from a toner storage unit C to a developing unit B. FIG. 6B shows a state in which a flow passage (first exhaust passage) is formed for the air intake and exhaust unit 135 discharging air drawn from the outside, to the toner storage unit C through the first conveyance passage 27 and the second conveyance passage 28 in the exhaust operation.

At the time of toner replenishment, the air-port-side intake valve 36a of the intake air switching portion 36 is placed in “closed” state, the outside-air-side intake valve 36b is placed in “opened” state, the air-port-side exhaust valve 37a of the exhaust air switching portion 37 is placed in “opened” state, and the outside-air-side exhaust valve 37b is placed in “closed”state under the control of a control portion 100.

As shown in FIG. 6A, the air intake and exhaust unit 135 is a passage that connects the volume changing portion 135a and a toner storage portion 16 and has a first passage including an intake passage 135b, the intake air switching portion 36, and the air pipe 21. The first passage is configured to communicate with the outside at midpoint in the passage by an intake opening 36c (first opening) at which an outside-air-side intake valve 36b (first outside-air valve) opens and closes in the intake air switching portion 36. In the first passage configured thus, when the air-port-side intake valve 36a (first passage valve) closer to the toner storage portion 16 than the intake opening 36c closes the first passage, the outside-air-side intake valve 36b (first outside-air valve) opens the intake opening 36c (first opening), and the volume changing portion 135a increases the volume, the intake passage valve 135d (first intake valve) is opened and the exhaust passage valve 135e (first exhaust valve) is closed. Thus, as shown in FIG. 6A, the volume changing portion 135a is caused to communicate with the outside through the intake opening 36c, so that a first intake passage is formed between the intake opening 36c and the volume changing portion 135a and an airflow is formed in the direction indicated by an arrow F31. That is, the first intake passage is formed in the first passage.

Furthermore, as shown in FIG. 6B, the air intake and exhaust unit 135 is a passage that connects the volume changing portion 135a and the toner storage portion 16 and has a second passage including the exhaust passage 135c, the exhaust air switching portion 37, and the air pipe 21. The second passage is different from the first passage. The second passage is configured to communicate with the outside at midpoint in the passage by an exhaust opening 37c (second opening) at which the outside-air-side exhaust valve 37b (second outside-air valve) opens and closes in the exhaust air switching portion 37. In the second passage configured thus, when the air-port-side exhaust valve 37a (second passage valve) closer to the toner storage portion 16 than the exhaust opening 37c opens the second passage, the outside-air-side exhaust valve 37b closes the exhaust opening 37c, and the volume changing portion 135a reduces the volume, the exhaust passage valve 135e (second passage valve) opens and the intake passage valve 135d (first passage valve) closes. Thus, as shown in FIG. 6B, the volume changing portion 135a communicates with the toner storage portion 16, so that a passage (first exhaust passage) formed between the volume changing portion 135a and the toner storage portion 16 forms an airflow in the direction indicated by an arrow F32. That is, the first exhaust passage is formed in the second passage.

In this state, when the volume changing portion 135a of the air intake and exhaust unit 135 repeatedly increases and reduces the volume in a continuous manner, an airflow in the direction indicated by the arrow F31 in FIG. 6A and an airflow in the direction indicated by the arrow F32 in FIG. 6B are alternately generated. Air drawn from the intake air switching portion 36 passes through the air intake and exhaust unit 135 and the exhaust air switching portion 37 and flows into an air chamber 17. The air having passed through the first filter 18 and flowed into the toner storage portion 16 passes through the first conveyance passage 27 and the second conveyance passage 28 and flows out of a second filter 26. As described above, a toner chamber 12 of the developing unit B can be replenished with toner T, and toner that has not reached the toner chamber 12 is accumulated in the first conveyance passage 27 and the second conveyance passage 28.

### Airflow at Time of Collection of Accumulated Toner

Referring to FIGS. 7A and 7B, an airflow at the time of collection of accumulated toner will be described below. FIG. 7A shows a state in which a flow passage (second intake passage) is formed for sucking air from the toner storage portion 16 to the air intake and exhaust unit 135 in an intake operation for sucking air from the toner storage unit C and the developing unit B. FIG. 7B shows a state in which a flow passage (second exhaust passage) is formed for the air intake and exhaust unit 135 discharging air sucked from the toner storage portion 16 in the intake operation.

At the time of collection of accumulated toner, the air-port-side intake valve 36a of the intake air switching portion 36 is placed in “opened” state, the outside-air-side intake valve 36b is placed in “closed” state, the air-port-side exhaust valve 37a of the exhaust air switching portion 37 is placed in “closed” state, and the outside-air-side exhaust valve 37b is placed in “opened” state under the control of the control portion 100.

As shown in FIG. 7A, the air intake and exhaust unit 135 has a first passage including the air pipe 21, the intake air switching portion 36, and the intake passage 135b. In the first passage, when the air-port-side intake valve 36a (first passage valve) opens the first passage, the outside-air-side intake valve 36b (first outside-air valve) closes the intake opening 36c (first opening), and the volume of the volume changing portion 135a increases, the intake passage valve 135d (second intake valve) is opened and the exhaust passage valve 135e (second exhaust valve) is closed. Thus, as shown in FIG. 7A, the volume changing portion 135a is caused to communicate with the toner storage portion 16, so that an airflow in the direction indicated by an arrow F41 is formed by the passage (second intake passage) formed between the volume changing portion 135a and the toner storage portion 16. That is, a second intake passage is formed in the first passage.

Furthermore, as shown in FIG. 7B, the air intake and exhaust unit 135 has a second passage including the exhaust passage 135c, the exhaust air switching portion 37, and the air pipe 21. In the second passage, when the air-port-side exhaust valve 37a closes the second passage, the outside-air-side exhaust valve 37b opens the exhaust opening 37c (second opening), and the volume of the volume changing portion 135a decreases, the exhaust passage valve 135e (second exhaust valve) is opened and the intake passage valve 135d (second intake valve) is closed. Thus, as shown in FIG. 7B, the volume changing portion 135a is caused to communicate with the outside through the exhaust opening 37c, so that an airflow in the direction indicated by an arrow F42 is formed by the passage (second exhaust passage) formed between the volume changing portion 135a and the exhaust opening 37c. That is, a second exhaust passage is formed in the second passage.

In this state, when the volume changing portion 135a of the air intake and exhaust unit 135 continuously increases and reduces in volume, an airflow is generated in the direction indicated by arrows F41 and F42 in the drawings. Air drawn from the second filter 26 passes through the second conveyance passage 28 and the first conveyance passage 27 and reaches the toner storage portion 16. The air that has passed through the first filter 18 and flowed into the air chamber 17 passes through the intake air switching portion 36 and the air intake and exhaust unit 135 and flows out of the exhaust air switching portion 37. Thus, as described above, at least part of toner accumulated in the first conveyance passage 27 and the second conveyance passage 28 can be collected in the toner storage portion 16.

According to the configuration, even if Vp<V1+V2 is set, toner replenishment and the collection of accumulated toner can be performed. As a result, variations in the amount of conveyed toner are suppressed when the toner is conveyed by air, achieving stable toner replenishment.

### Method for Filling Toner Storage Unit C With Toner

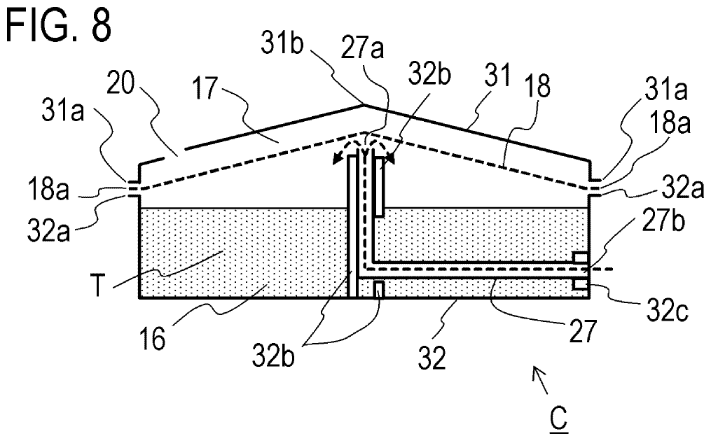

FIG. 8 is a schematic cross-sectional view of toner supplied into the toner storage unit C, showing a state in which the toner is supplied into the toner storage unit C. As shown in FIG. 8, when the toner storage unit C is to be filled with the toner, the position of the toner storage unit C is set in a replenishment position that is vertically inverted from the use position. By inverting the top and bottom of the toner storage unit C thus, the second inflow/outflow port 27b (discharge port) can be used as a filling port of the toner T. When the toner T is supplied, for example, air is sucked from the air port 20 by using the air intake and exhaust unit 35. Thus, the toner T is supplied to the toner storage portion 16 from the second inflow/outflow port 27b, which serves as a filling port, through the first conveyance passage 27.

Since the first inflow/outflow port 27a is located in the upper part of the toner storage portion 16, the toner T can be continuously supplied such that the first inflow/outflow port 27a is not buried in the toner T being supplied. Moreover, in the present embodiment, since the first inflow/outflow port 27a is located at a position near the center in the horizontal direction, the toner is ejected in a well-balanced manner in the horizontal direction. In addition, during use after the first inflow/outflow port 27a is mounted in the image forming apparatus, the first inflow/outflow port 27a is located at a position where the toner is easily discharged, so that the first inflow/outflow port 27a is located such that toner supply is facilitated by inverting the top and bottom. Furthermore, when the top and bottom of the toner storage unit C are reversed, the top surface of the toner storage portion 16 is covered with the first filter 18, achieving high degassing efficiency. This eliminates the need for providing another opening for filling the toner storage unit C, and also eliminates the need for providing another seal or lid to cover the opening for filling. Moreover, when recycling the toner storage unit C, the second inflow/outflow port 27b (discharge port) can be used to refill the unit without disassembling the unit, thereby improving the recyclability.

The configurations of the embodiments can be combined with each other as much as possible.

According to the present disclosure, the amount of a developer conveyed from the developer container to the developing unit can be stabilized.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159527, filed on Sep. 13, 2024, which is hereby incorporated by reference herein in its entirety.

What is claimed is:

1. An image forming apparatus that forms an image on a recording material, comprising:
an apparatus main body having a photosensitive drum and a developing unit provided with a receiving port for receiving developer, the developing unit having a developing roller for supplying, to the photosensitive drum, the developer received from the receiving port;
a developer container that contains the developer, is provided with a discharge port, and is attachable to and detachable from the apparatus main body; and
a developer conveyance passage that connects the discharge port and the receiving port,
wherein the apparatus main body includes an intake and exhaust portion that is capable of performing an exhaust operation for supplying air to the developer container and an intake operation for sucking air from the developer container, and
wherein the intake and exhaust portion
forms a first flow of air flowing from the developer container to the developing unit through the developer conveyance passage by the exhaust operation to supply the developer from the developer container to the developing unit, and
forms a second flow of air flowing from the developing unit to the developer container through the developer conveyance passage by the intake operation.

2. The image forming apparatus according to claim 1,
wherein the developer container includes:
a developer storage chamber that stores the developer and is provided with the discharge port;
a first filter that allows passage of air and prevents passage of the developer; and
an air chamber that is separated from the developer storage chamber by the first filter and is provided with an air receiving port for receiving air supplied from the intake and exhaust portion;
wherein the developing unit includes a developer storage portion and a second filter that allows passage of air and prevents passage of the developer between the developer storage portion and outside of the developing unit,
wherein the first flow reaches outside of the developing unit through the second filter, and
wherein the second flow is formed by air flowing from the outside of the developing unit into the developer storage portion through the second filter.

3. The image forming apparatus according to claim 2,
wherein the discharge port is configured to communicate with inside of the developer storage chamber through a first tube provided in the developer storage chamber,
wherein the developer conveyance passage is formed by a second tube connecting the discharge port and the receiving port,
wherein the intake and exhaust portion includes a flexible container having a variable volume and an intake and exhaust port that connects inside and outside of the flexible container,
wherein the intake and exhaust portion is configured to exhaust air from the intake and exhaust port to outside by reducing a volume of the flexible container and suck air to inside from the intake and exhaust port by increasing the volume of the flexible container, the intake and exhaust port communicating with the developer storage chamber, and
wherein
Vp>V1+V2 is set where V1 is a volume of the first conveyance passage formed by the first tube, V2 is a volume of the second conveyance passage formed by the second tube, and Vp is the variable volume of the flexible container.

4. The image forming apparatus according to claim 3,
wherein the intake and exhaust portion is a bellows pump.

5. The image forming apparatus according to claim 3,
wherein the air chamber is located under the developer storage chamber,
wherein the first tube that is opened to the inside of the developer storage chamber has an opening facing the first filter, and
wherein the first filter has a recessed shape in which an area facing the opening of the first tube is most recessed downward.

6. The image forming apparatus according to claim 2,
wherein the intake and exhaust portion includes:
a volume varying portion that has a variable volume;
a first intake passage for sucking air from outside into the volume varying portion;
a first exhaust passage for exhausting air from the volume varying portion to the developer storage chamber;
a first intake valve that opens and closes the first intake passage, the first intake valve being configured to open in a case where the volume of the volume varying portion increases, and to close in a case where the volume of the volume varying portion decreases; and
a first exhaust valve that opens and closes the first exhaust passage, the first exhaust valve being configured to open in a case where the volume of the volume varying portion decreases, and close in a case where the volume of the volume varying portion increases; and
wherein the exhaust operation is performed by repeatedly increasing and reducing the volume of the volume varying portion.

7. The image forming apparatus according to claim 6,
wherein the intake and exhaust portion includes:
a volume varying portion that has a variable volume;
a second intake passage for sucking air from the developer storage chamber to the volume varying portion;
a second exhaust passage for exhausting air from the volume varying portion to outside;
a second intake valve that opens and closes the second intake passage, the second intake valve being configured to open in a case where the volume of the volume varying portion increases, and close in a case where the volume of the volume varying portion decreases; and
a second exhaust valve that opens and closes the second exhaust passage, the second exhaust valve being configured to open in a case where the volume of the volume varying portion decreases, and close in a case where the volume of the volume varying portion increases; and
wherein the intake operation is performed by repeatedly increasing and reducing the volume of the volume varying portion.

8. The image forming apparatus according to claim 7,
wherein the intake and exhaust portion includes:
a first passage that connects the volume varying portion and the developer storage chamber and has a first opening that communicates with outside at midpoint in the first passage;
a first outside-air valve that opens and closes the first opening;
a first passage valve that opens and closes the first passage on a side closer to the developer storage chamber than the first opening in the first passage;
a second passage different from the first passage, the second passage connecting the volume varying portion and the developer storage chamber and having a second opening communicating with outside at midpoint in the second passage;
a second outside-air valve that opens and closes the second opening; and
a second passage valve that opens and closes the second passage on a side closer to the developer storage chamber than the second opening in the second passage,
wherein in a case where the exhaust operation is performed,
the first outside-air valve is opened, the first passage valve is closed, the second outside-air valve is closed, the second passage valve is opened,
the first passage forms the first intake passage, and
the second passage forms the first exhaust passage,
wherein in a case where the intake operation is performed,
the first outside-air valve is closed, the first passage valve is opened, the second outside-air valve is opened, the second passage valve is closed,
the first passage forms the second intake passage, and
the second passage forms the second exhaust passage.

9. The image forming apparatus according to claim 6,
wherein the volume varying portion is a diaphragm pump.

10. A method for filling a developer container with developer, the developer container being attachable to and detachable from an apparatus main body of an image forming apparatus,
wherein the developer container includes:
a developer storage chamber that stores the developer and is provided with a discharge port for the developer;
a filter that allows passage of air and prevents passage of the developer; and
an air chamber that is separated from the developer storage chamber by the filter and is provided with an air receiving port for receiving air supplied from an intake and exhaust portion of the apparatus main body,
wherein the air chamber is configured to be mounted, in the apparatus main body, in a position located under the developer storage chamber, and
wherein in a case where the developer storage chamber is to be filled with the developer, the air chamber is positioned on the developer storage chamber, and the developer is supplied into the developer storage chamber from the discharge port while air is sucked from the air receiving port, the discharge port serving as a developer filling port.
